(19) United States
(12) Patent Application Publication
(10) Pub. No.: US 2026/0178623 A1
(43) Pub. Date: Jun. 25, 2026

(54) PROMPT GENERATION SYSTEM AND PROMPT MANAGEMENT METHOD

(71) Applicant: Hitachi, Ltd., Tokyo (JP)

(72) Inventors: Yoshihiro WAKISAKA, Tokyo (JP); Noriyuki HAGA, Tokyo (JP); Tetsuro ADACHI, Tokyo (JP)

(21) Appl. No.: 19/426,607

(22) Filed: Dec. 19, 2025

(30) Foreign Application Priority Data
Dec. 23, 2024 (JP) 2024-225987

(51) Int. Cl. G06F 16/3329

(52) U.S. Cl. CPC G06F 16/3329

(57) ABSTRACT

A data processing unit includes a prompt sentence for designating extraction target information to be extracted from a document. The data processing unit generates an input prompt including a prompt sentence so as to be input to a generative AI model. Furthermore, the data processing unit determines additional information that is included in extracted information extracted by the generative AI model in response to the input prompt and that does not correspond to the extraction target information, and adds to the prompt sentence a sentence for designating the extraction target information that is new and matches the additional information.

### CROSS-REFERENCE TO PRIOR APPLICATION

This application relates to and claims the benefit of priority from Japanese Patent Application No. 2024-225987 filed on Dec. 23, 2024 the entire disclosure of which is incorporated herein by reference.

### BACKGROUND

The present disclosure relates to a prompt generation system and a prompt management method.

In recent years, it is desired to automatically extract desired information from documents such as product catalogs, system specifications, part lists, and manuals to improve efficiency of business. However, the documents are provided in various formats, and therefore it is not easy to accurately extract desired information.

By contrast with this, Japanese Patent Application Publication No. 2008-27133 discloses a technique of specifying a ledger format on the basis of a ledger image, and reading described information by using a ledger pattern having the same format as the specified format among a plurality of ledger patterns registered in advance in a ledger processing apparatus that reads described information described in ledger images showing ledgers.

### SUMMARY

However, the technique described in Japanese Patent Application Publication No. 2008-27133 needs to register ledger patterns, for which formats have been defined, in advance, and therefore there is a problem in that it is difficult to apply this technique in a case where the number of formats is extremely large or in a case where a document in an unknown format is included.

Furthermore, in recent years, it is also conceivable to extract desired information from documents by using a generative AI (Artificial Intelligence) that has become prevalent rapidly. However, to accurately extract desired information using a generative AI model, a prompt that is to be input to the generative AI model needs to be appropriately adjusted, yet it is not easy to adjust.

It is an object of the present disclosure to provide a prompt generation system and a prompt management method that can accurately extract desired information from a document.

A prompt generation system according to one aspect of the present disclosure is a prompt generation system generating an input prompt for causing a generative AI model to extract information from a document, and includes: a processor; and a memory, the memory is configured to store a prompt sentence for designating extraction target information to be extracted from the document, and the processor is configured to generate the input prompt including the prompt sentence so as to be input to the generative AI model, and discriminate additional information that is included in extracted information extracted by the generative AI model in response to the input prompt and that does not correspond to the extraction target information, and adds to the prompt sentence a sentence for designating the extraction target information that is new and matches the additional information.

According to the present invention, it is possible to accurately extract desired information from a document.

### BRIEF DESCRIPTION OF THE DRAWINGS

FIG. 1 is a diagram illustrating a functional configuration of a prompt generation system according to a first embodiment of the present disclosure;

FIG. 2 is a diagram illustrating an example of a document;

FIG. 3 is a diagram illustrating an example of an item type table;

FIG. 4 is a diagram illustrating an example of extracted information;

FIG. 5 is a diagram illustrating an example of discrimination result information;

FIG. 6 is a diagram illustrating an example of a document input UI;

FIG. 7 is a diagram illustrating an example of a table edit UI;

FIG. 8 is a diagram illustrating an example of an extracted information browse UI;

FIG. 9 is a diagram illustrating an example of a hardware configuration of the prompt generation system;

FIG. 10 is a flowchart for describing an example of extraction processing;

FIG. 11 is a diagram for describing a specific example of determination processing;

FIG. 12 is a diagram for describing an example of update processing;

FIG. 13 is a flowchart for describing an example of the update processing;

FIG. 14 is a diagram illustrating a functional configuration of the prompt generation system according to a second embodiment of the present disclosure;

FIG. 15 is a diagram illustrating an example of a document type table; and

FIG. 16 is a diagram illustrating another example of the update processing.

### DETAILED DESCRIPTION OF THE EMBODIMENT

Hereinafter, embodiments of the present disclosure will be described with reference to the drawings.

### First Embodiment

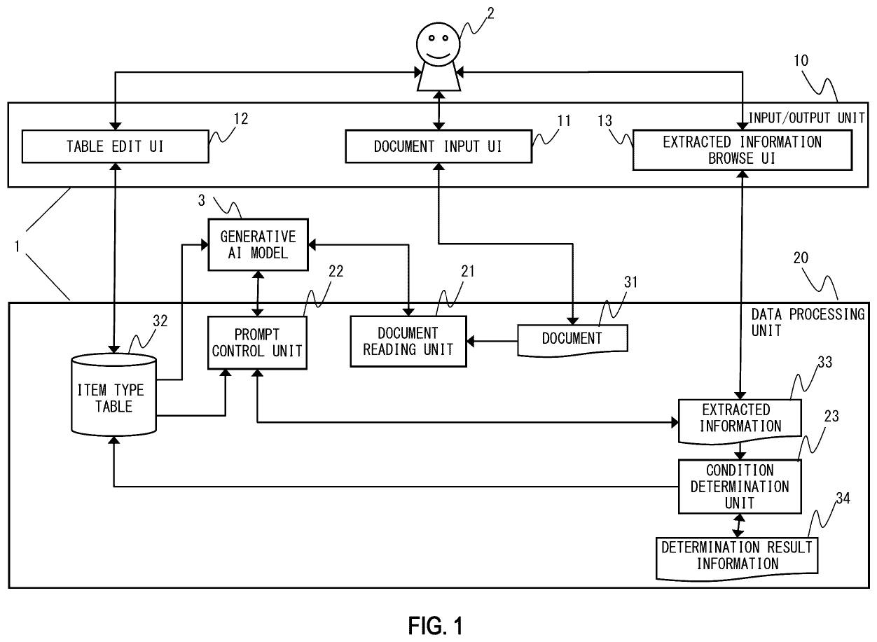

FIG. 1 is a diagram illustrating a functional configuration of a prompt generation system 1 according to the first embodiment of the present disclosure. The prompt generation system 1 illustrated in FIG. 1 includes an input/output unit 10 and a data processing unit 20.

The input/output unit 10 receives an input of and outputs information from and to a user 2 who uses the prompt generation system 1. More specifically, the input/output unit 10 presents a document input UI (User Interface) 11, a table edit UI 12, and an extracted information browse UI 13 to the user 2, and accepts various pieces of information via these UIs.

The document input UI 11 is an interface for inputting a document 31 that is an extraction source for extracting desired information. The document 31 is a product catalog, a system specification, or the like. In the present embodiment, item information associated with each item is described per item related to a predetermined target in the document 31. There may be a plurality of predetermined targets. In a case where, for example, the document 31 is a product catalog, each product is a target. Furthermore, in a case where the document 31 is a system specification, each function, each component (such as hardware), both of the system, or the like is a target. Examples of the item information include description sentences indicating item contents, values, or the like.

The table edit UI 12 is an interface for editing an item type table 32 that is extraction management information related to extraction target information to be extracted from the document 31. The extraction target information is item information associated with a predetermined target item in the present embodiment. There may be a plurality of target items. The item type table 32 indicates an item type that is a type (attribute) indicating a characteristic of a target item, a discrimination criterion for discriminating the target item, and a prompt sentence for designating extraction target information to the generative AI model 3 per target item. The item type indicates, for example, a “format”, a “language”, or the like. More specifically, the discrimination criterion indicates a characteristic of the target item.

The extracted information browse UI 13 is an interface for outputting extracted information 33 that is information extracted from the document 31 so as to enable the user 2 to browse the extracted information 33.

The data processing unit 20 is a processing unit for receiving an input of an input prompt for causing the generative AI model 3 to extract the extraction target information from the document 31, and acquiring information extracted by the generative AI model 3 from the document 31. More specifically, the data processing unit 20 includes a document reading unit 21, a prompt input unit 22, and a condition determination unit 23.

The document reading unit 21 causes the generative AI model 3 to read the document 31, and causes the generative AI model 3 to specify an item type of a target item included in the document 31 using the discrimination criterion in the item type table 32.

The prompt input unit 22 inputs to the generative AI model 3 an input prompt including a prompt sentence associated with the target item based on the item type table 32, and causes the generative AI model 3 to extract item information of the target item as the extracted information 33 from the document 31.

The condition determination unit 23 updates the prompt sentence in the item type table 32 based on the item type table 32 and the extracted information 33. More specifically, the condition determination unit 23 determines additional information that does not correspond to the extraction target information designated by the prompt sentence in the extracted information 33 per target item, and generates discrimination result information 34 indicating this additional information. Furthermore, the condition determination unit 23 updates the prompt sentence in the item type table 32 based on the discrimination result information 34. More specifically, the condition determination unit 23 adds to the prompt sentence a sentence for designating new extraction target information matching the additional information.

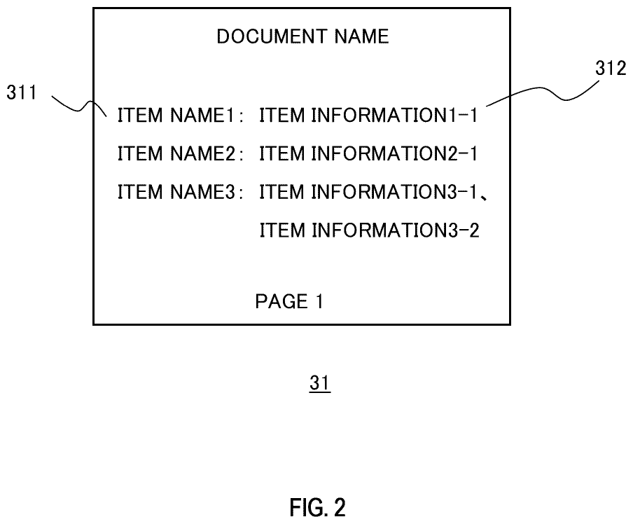

FIG. 2 is a diagram illustrating an example of the document 31. Item information 312 is described per item 311 in the document 31 illustrated in FIG. 2. Note that, in the present embodiment, the document 31 includes pages separately provided for respective targets, and FIG. 2 illustrates a first page of the document 31.

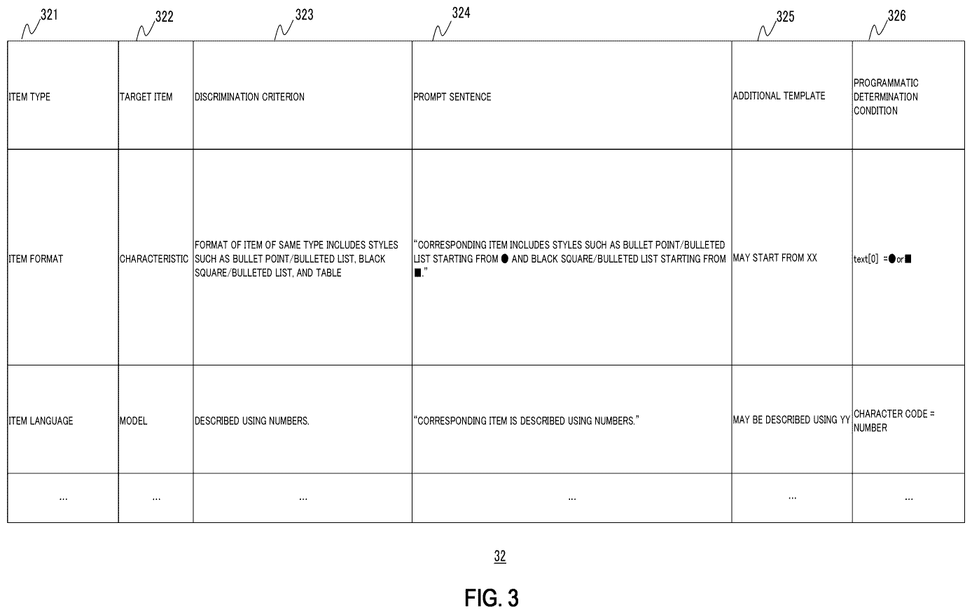

FIG. 3 is a diagram illustrating an example of the item type table 32. The item type table 32 illustrated in FIG. 3 includes fields 321 to 326 per record.

In the field 321, an item type of a target item is stored. In the field 322, a target item name of the target item is stored. In the field 323, a characteristic of the target item is stored as the discrimination criterion for discriminating the target item. In the field 324, a prompt sentence for designating item information of the target item as extraction target information to the generative AI model 3 is stored. In the field 325, an additional template that is template information of an additional sentence to be added to the prompt sentence is stored. In the field 326, a programmatic determination condition that is a determination condition for determining whether or not the prompt sentence needs to be updated is stored.

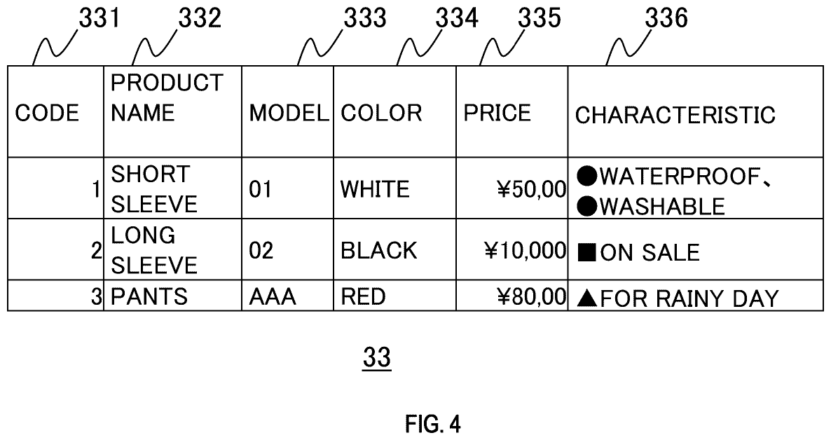

FIG. 4 is a diagram illustrating an example of the extracted information 33. The extracted information 33 illustrated in FIG. 4 includes fields 331 to 336 per record.

In the field 331, a code that is identification information for identifying a target is stored. In the fields 332 to 336, item information of a target item related to the target is stored. In an example in FIG. 3, a product name of the target is stored in the field 332, a model of the target is stored in the field 333, a color of the target is stored in the field 334, a price of the target is stored in the field 335, and a characteristic of the target is stored in the field 336.

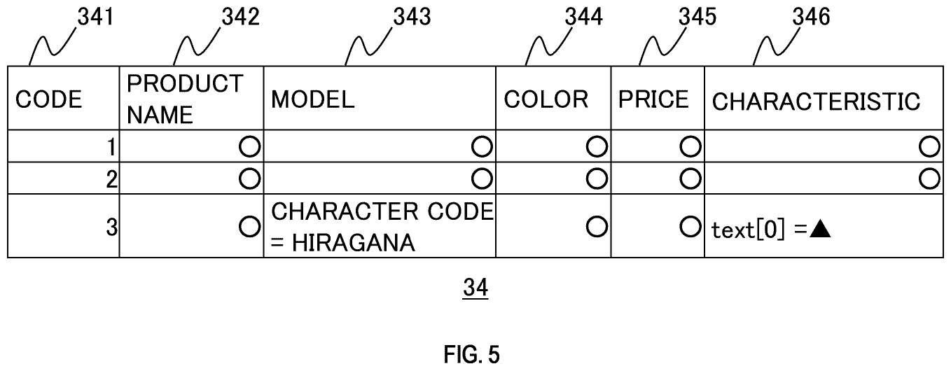

FIG. 5 is a diagram illustrating an example of the discrimination result information 34. The discrimination result information 34 illustrated in FIG. 5 includes fields 341 to 346 per record.

In the field 341, a code that is identification information for identifying a target is stored. In the fields 342 to 346, a discrimination result of additional information of each target item related to the target is stored. In an example in FIG. 5, a discrimination result of a product name is stored in the field 342, a discrimination result of a model is stored in the field 343, a discrimination result of a color is stored in the field 344, a discrimination result of a price is stored in the field 345, and a discrimination result of a characteristic is stored in the field 346. Furthermore, the discrimination result indicates “○” if there is no additional information, and indicates this additional information if there is the additional information.

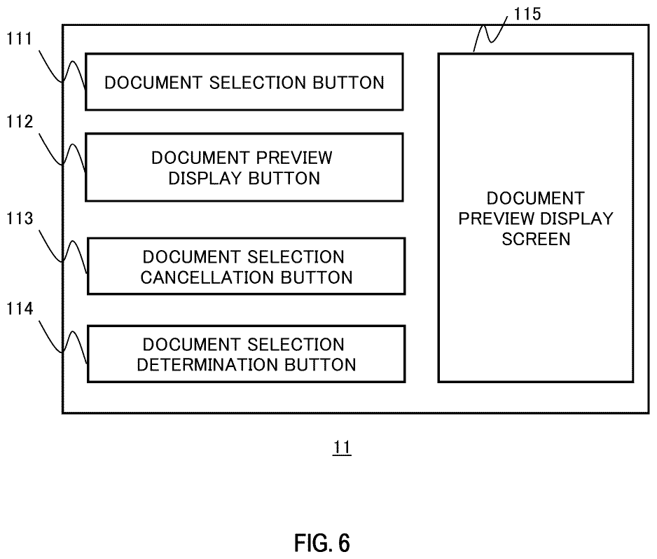

FIG. 6 is a diagram illustrating an example of the document input UI 11. The document input UI 11 illustrated in FIG. 6 includes a document selection button 111, a document preview display button 112, a document selection cancellation button 113, a document selection determination button 114, and a document preview display screen 115.

The document selection button 111 is a button for selecting the document 31 to be input to the prompt generation system 1. The document preview display button 112 is a button for previewing the document 31 selected by the document selection button 111. The document selection cancellation button 113 is a button for canceling selection of the document 31 performed by the document selection button 111. The document selection determination button 114 is a button for determining selection of the document 31 performed by the document selection button 111, and inputting this document 31 to the prompt generation system 1. The document preview display screen 115 is an area for displaying the preview of the document 31 selected by the document selection button 111, and displays, for example, the document 31 illustrated in FIG. 2.

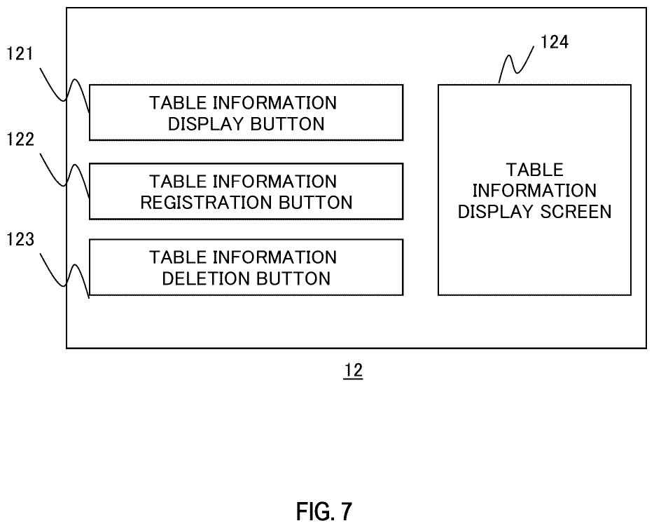

FIG. 7 is a diagram illustrating an example of the table edit UI 12. The table edit UI 12 illustrated in FIG. 7 includes a table information display button 121, a table information registration button 122, a table information deletion button 123, and a table information display screen 124.

The table information display button 121 is a button for displaying the item type table 32. The table information registration button 122 is a button for registering the item type table 32. The table information deletion button 123 is a button for deleting the item type table 32. The table information display screen 124 is an area for displaying the item type table 32, and the item type table 32 displayed on the table information display screen 124 may be edited by an operation of the user 2.

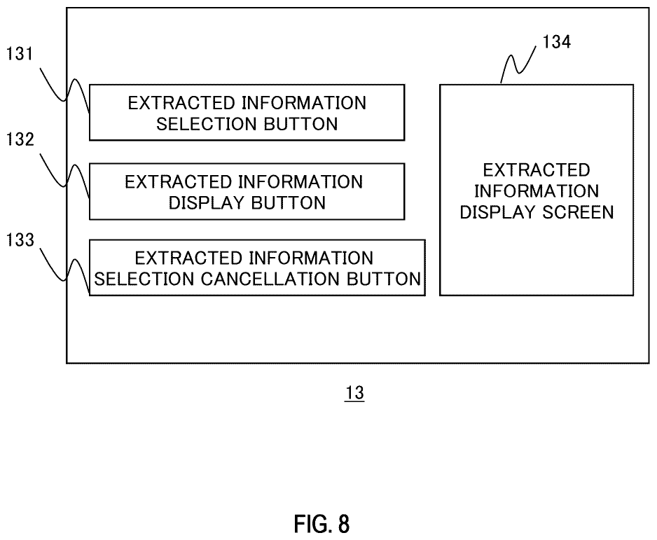

FIG. 8 is a diagram illustrating an example of the extracted information browse UI 13. The extracted information browse UI 13 illustrated in FIG. 8 includes an extracted information selection button 131, an extracted information display button 132, an extracted information selection cancellation button 133, and an extracted information display screen 134.

The extracted information selection button 131 is a button for selecting the extracted information 33. The extracted information display button 132 is a button for displaying the extracted information 33 selected by the extracted information selection button 131. The extracted information selection cancellation button 133 is a button for canceling selection of the extracted information 33 performed by the extracted information selection button 131. The extracted information display screen 134 is an area for displaying the extracted information 33 selected by the extracted information selection button 131.

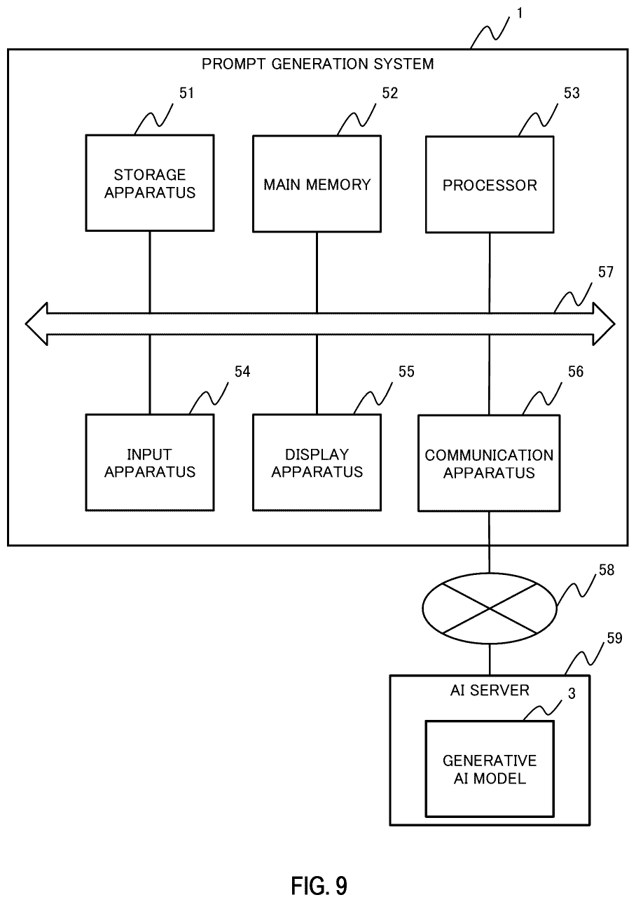

FIG. 9 is a diagram illustrating an example of a hardware configuration of the prompt generation system 1. The prompt generation system 1 illustrated in FIG. 9 includes a storage apparatus 51, a main memory 52, a processor 53, an input apparatus 54, a display apparatus 55, and a communication apparatus 56, and these components are coupled via a bus 57.

The storage apparatus 51 is an apparatus that records data in a writable and readable manner, and stores programs that define operations of the processor 53 and various pieces of information used and generated by these programs. The main memory 52 is used as a work area of the processor 53, and at least temporarily stores the various pieces of information used and generated by the programs. The various pieces of information such as the document 31, the item type table 32, the extracted information 33, and the discrimination result information 34 illustrated in FIG. 1 are stored in at least the storage apparatus 51 or the main memory 52 that constitute a memory of the prompt generation system 1.

The processor 53 reads the program stored in the storage apparatus 51 out to the main memory 52 to implement a function unit corresponding to the program using the main memory 52 as the work area. More specifically, the processor 53 implements respective function units (such as the document reading unit 21, the prompt input unit 22, and the condition determination unit 23) of the prompt generation system 1 illustrated in FIG. 1. Hence, in this description, a subject of processing performed using each function unit as an operation subject may be the processor 53.

The input apparatus 54 is an apparatus that receives an input of various pieces of information from the user 2 of the prompt generation system 1, and this information is used by the processor 53. The display apparatus 55 is an apparatus that displays the various pieces of information such as each of the UIs 11 to 13 illustrated in FIG. 1. The communication apparatus 56 is communicably coupled to an external apparatus via a network 58 or the like, and transmits and receives information to and from this external apparatus. In the present embodiment, the external apparatus is an AI server 59 included in the generative AI model 3. Note that the generative AI model 3 may be provided inside the prompt generation system 1.

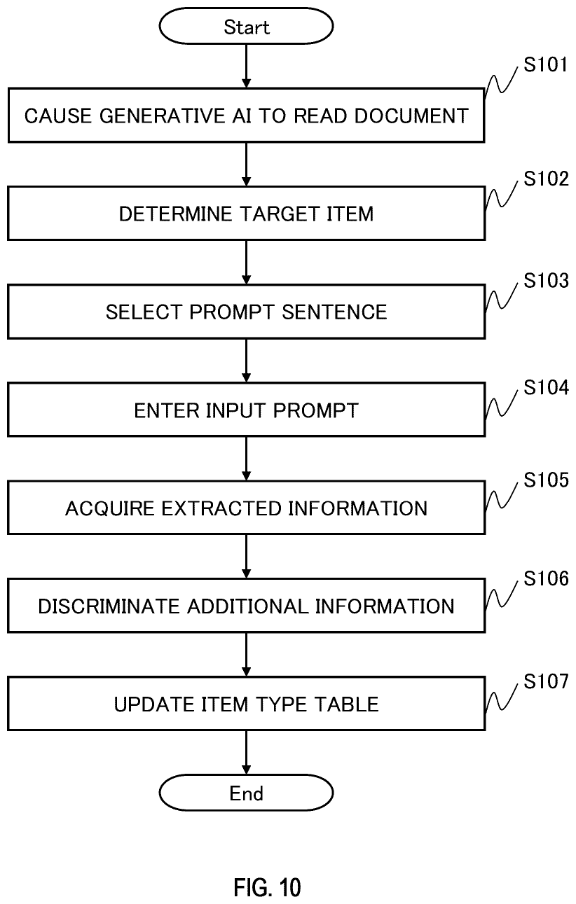

FIG. 10 is a flowchart for describing an example of extraction processing of extracting extraction target information by the prompt generation system.

According to the extraction processing, the document reading unit 21 of the data processing unit 20 causes the generative AI model 3 to read the document 31 input using the document input UI 11 (step S101). Furthermore, the document reading unit 21 causes the generative AI model 3 to determine an item of an item type that matches with the discrimination criterion as a target item from items in the document 31 based on the item type table 32 (step S102).

The prompt input unit 22 selects a prompt sentence associated with the target item from the item type table 32 (step S103), and generates an input prompt including this selected prompt sentence and inputs the input prompt to the generative AI model 3 (step S104). In addition to the selected prompt sentence, the input prompt may include another prompt sentence such as a common sentence that is common between all target items. Examples of the common sentence include “Corresponding item may include no description. Output empty field in this case.” and the like. Furthermore, the common sentence may be defined in the item type table 32.

The generative AI model 3 extracts item information of a target item from the document 31 in response to an input prompt, and outputs the item information. The condition determination unit 23 acquires the information output from the generative AI model 3 as the extracted information 33, and displays the extracted information 33 using the extracted information browse UI 13 of the input/output unit 10 (step S105). Note that the generative AI model 3 may extract not only information directly designated by the input prompt, but also additional information matching the input prompt.

The condition determination unit 23 executes determination processing of discriminating additional information that does not correspond to the extraction target information included in the item information in the extracted information 33 based on the programmatic determination condition associated with the target item in the item type table 32 per target item, and generating the discrimination result information 34 indicating this discrimination result (step S106).

The condition determination unit 23 executes update processing of updating the item type table 32 based on the discrimination result information 34 (step S107), and ends the processing.

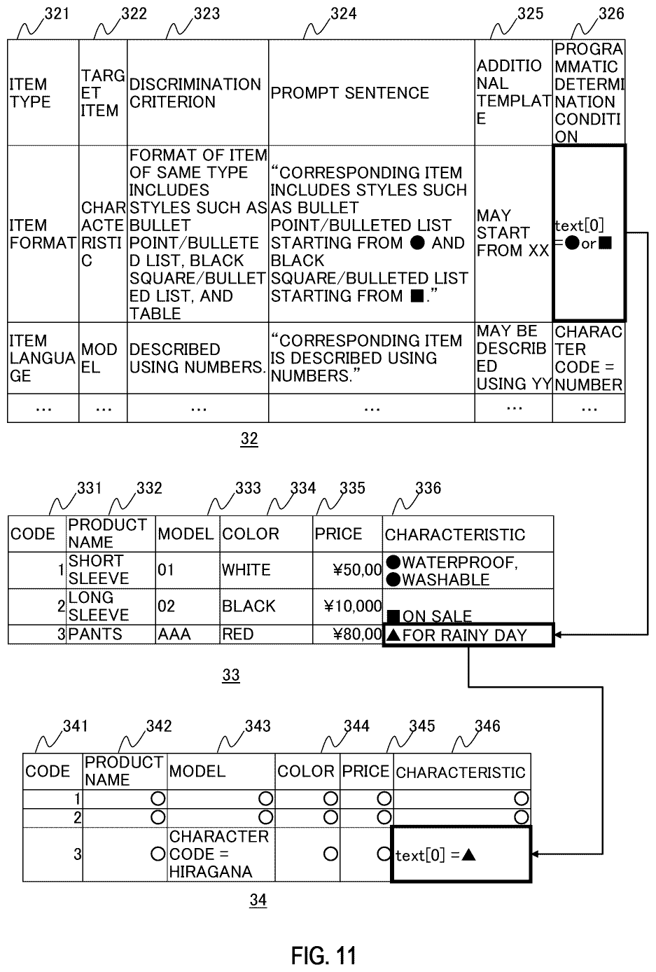

FIG. 11 is a diagram for describing a specific example of determination processing in step S106 in FIG. 10.

According to the determination processing, the condition determination unit 23 determines whether or not item information of a target item matches with the programmatic determination condition associated with the target item per target item of each target (i.e., per field of the extracted information 33) included in the extracted information 33. Furthermore, the condition determination unit 23 discriminates the item information that does not match with the programmatic determination condition as the additional information that does not correspond to an extraction target item.

For example, since item information of a “characteristic” of code “1” is “●waterproof, ●washable”, the item information matches with a programmatic determination condition (“text[0] =● or ▪”, that is, a head (list marker) of the item information starts from “●” or “▪”). In this case, a discrimination result associated with the “characteristic” of code “1” in the discrimination result information 34 is “○”.

On the other hand, item information of a characteristic of code “3” is “▴ for rainy day” and does not match with the programmatic determination condition. That is, the generative AI model 3 also complements a bulleted list sentence that is not directly designated by the input prompt and starts from “▴” together with item information of the “characteristic”. In this case, the condition determination unit 23 decides that the item information does not match with the programmatic determination condition, and discriminates “▴ for rainy day” as the additional information that does not match with the extraction target information. The condition determination unit 23 stores a programmatic determination condition “text[0]=▴” indicating the additional information as a discrimination result associated with the “characteristic” of code “3” in the discrimination result information 34. Similarly, a discrimination result associated with a “model” of code “3” in the discrimination result information 34 is “character code=Hiragana”.

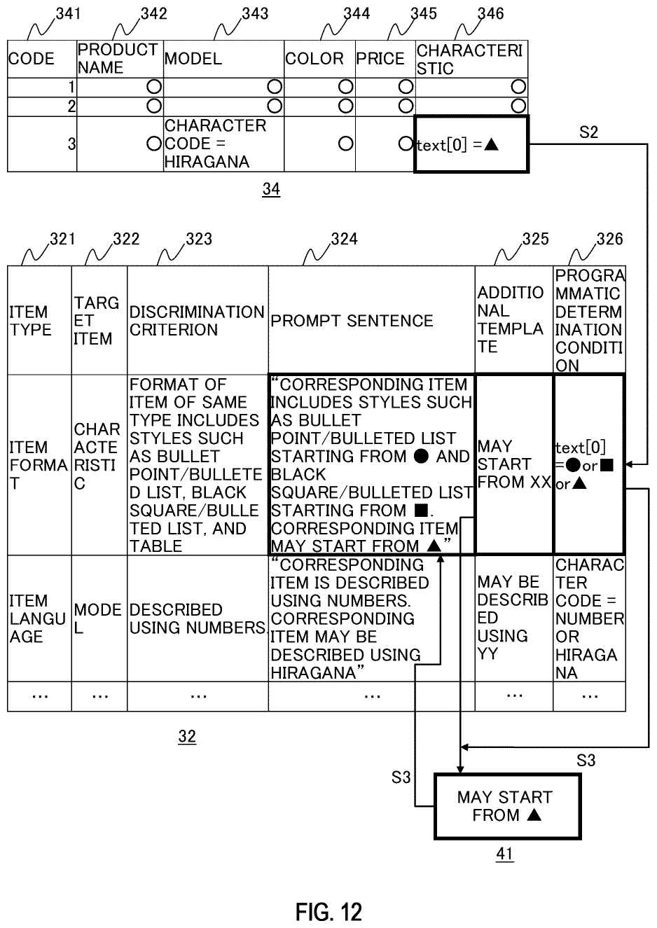

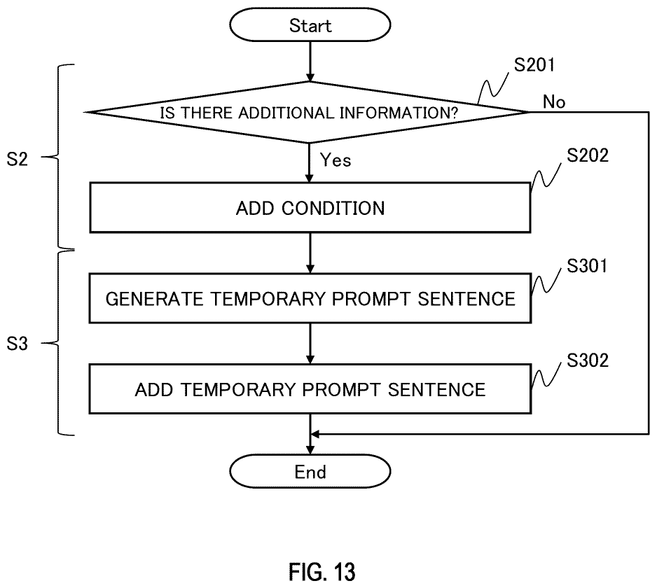

FIG. 12 is a diagram for describing an example of the update processing in step S107 in FIG. 10, and FIG. 13 is a flowchart for describing an example of the update processing.

As illustrated in FIG. 12, the update processing includes condition update processing S2 of updating the programmatic determination condition in the item type table 32 based on the discrimination result information 34, and prompt update processing S3 of updating a prompt sentence based on the updated programmatic determination condition and an additional template.

As the condition update processing S2, the condition determination unit 23 first determines whether or not there is a discrimination result other than “○”, that is, whether or not there is the additional information in the discrimination result information 34 (step S201).

If there is not the additional information (step S201: No), the condition determination unit 23 ends the update processing.

On the other hand, if there is the additional information (step S201: Yes), a new condition matching a discrimination result is added to the programmatic determination condition (the programmatic determination condition in a row having a row name matching with a column name of a field in which the additional information is present in the discrimination result information 34 in the item type table 32) associated with the discrimination result in which the additional information is present (step S202). More specifically, the new condition is a condition for determining additional information as extraction target information.

In, for example, an example in FIG. 12, a discrimination result associated with the item “characteristic” of code “3” in the discrimination result information 34 is “text[0]=▴”. Hence, “text[0]=▴” is added to the programmatic determination condition “text[0]=• or ▪” associated with the target item “characteristic” in the item type table 32. Thus, the programmatic determination condition is “text[0]=• or ▪ or ▴”. Similarly, a discrimination result associated with the item “model” of code “3” in the discrimination result information 34 is “character code =Hiragana”. Hence, “character code =Hiragana” is added to the programmatic determination condition “character code=number” associated with the target item “characteristic” in the item type table 32. Consequently, the programmatic determination condition is “character code=number or Hiragana”.

When the processing in step S202 ends, the condition determination unit 23 migrates to the prompt update processing S3, and generates a temporary prompt sentence obtained by inserting a value of a condition added to the programmatic determination condition in step S202 into an insertion portion (placeholder) in an additional template associated with a programmatic determination condition to which this condition has been added (step S301).

In, for example, the example in FIG. 12, the additional template of the target item “characteristic” is “May start from XX”, and “XX” indicates an insertion portion. In this case, since a new condition added to the programmatic determination condition of the target item “characteristic” is “text[0]=▴”, a temporary prompt sentence 41 associated with the target item “characteristic” is “May start from ▴.”. Similarly, a temporary prompt sentence of a target item “style” is “May be described using Hiragana.”.

Furthermore, the condition determination unit 23 adds the temporary prompt sentence to the prompt sentence (step S302), and ends processing. In, for example, the example in FIG. 12, the temporary prompt sentence “May start from ▴” is added to the prompt sentence of the target item “characteristic” so as to be read as “Corresponding item includes styles such as bullet point/bulleted list starting from • and black square/bulleted list starting from ▪. Corresponding item may start from ▴.”.

According to the above-described present embodiment, the main memory 52 stores a prompt sentence for describing extraction target information to be extracted from the document 31. The processor 53 generates an input prompt including a prompt sentence to input to the generative AI model 3. Furthermore, the processor 53 discriminates additional information that is included in the extracted information 33 extracted by the generative AI model 3 in response to the input prompt, and does not correspond to the extraction target information, and add to the prompt sentence an additional sentence for designating this additional information as the extraction target information. Consequently, it is possible to optimize the input prompt for causing the generative AI model 3 to extract desired extraction target information, and consequently it is possible to accurately extract desired information from the document 31.

Furthermore, in the present embodiment, the main memory 52 stores a prompt sentence for describing item information associated with a predetermined target item as the extraction target information per predetermined target item included in the item of the document 31. Consequently, it is possible to accurately extract the desired item information.

Furthermore, in the present embodiment, the main memory 52 stores the discrimination criterion that is a characteristic of the target item per target item. The processor 53 causes the generative AI model 3 to specify as the target item an item matching with the discrimination criterion from an item in the document 31, and generates the input prompt including a prompt sentence associated with the specified target item. In this case, it is possible to input to the generative AI model 3 the input prompt including the prompt sentence matching the target item in the document, so that it is possible to more accurately extract desired item information.

Furthermore, in the present embodiment, the main memory 52 stores the programmatic determination condition for determining the extraction target information included in the extracted information 33, and the processor 53 determines, as the additional information, information that does not match with the programmatic determination condition included in the extracted information 33 based on the programmatic determination condition, and add to the determination condition a new condition for determining the additional information as the extraction target information. In this case, it is possible to optimize determination on the additional information.

Furthermore, in the present embodiment, the processor 53 adds a sentence for describing the additional information as the extraction target information to a prompt sentence using the additional template. Consequently, it is possible to appropriately update the prompt sentence.

### Second Embodiment

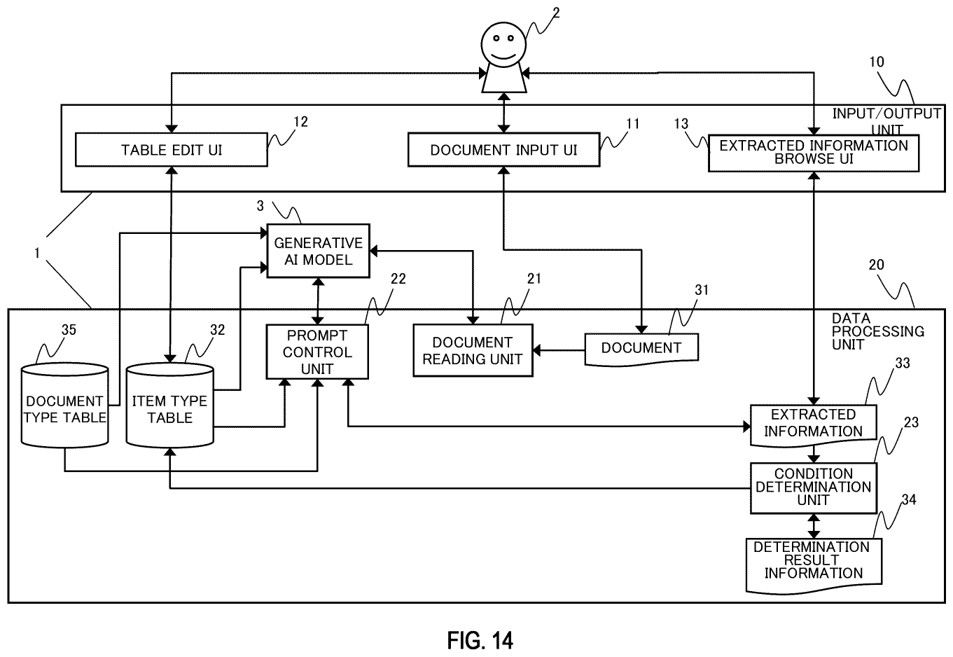

FIG. 14 is a diagram illustrating a functional configuration of the prompt generation system 1 according to the second embodiment of the present disclosure. The prompt generation system 1 illustrated in FIG. 14 differs from the prompt generation system 1 according to the first embodiment illustrated in FIG. 1 in further including a document type table 35 indicating a characteristic of a document type that is a type of the document 31 per document type. Furthermore, the item type table 32 is provided per document type. Each item type table 32 includes the discrimination criterion and the prompt sentence associated with the corresponding document type.

Note that the document type table 35 is stored in, for example, the storage apparatus 51 illustrated in FIG. 9. Furthermore, a function for editing the document type table 35 may be provided to the table edit UI 12, or a UI for editing the document type table 35 may be provided separately from the table edit UI 12.

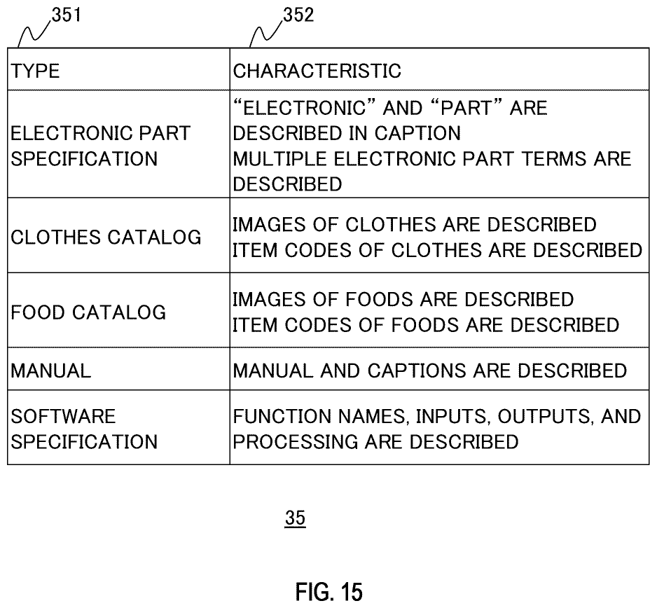

FIG. 15 is a diagram illustrating an example of the document type table 35. The document type table 35 illustrated in FIG. 15 includes fields 351 and 352 per record.

In the field 351, a document type is stored. In the field 352, characteristic information indicating a characteristic of the document type is stored.

In the present embodiment, when causing the generative AI model 3 to read the document 31, the document reading unit 21 causes the generative AI model 3 to specify a document type of the document 31 based on the document type table 35. The document reading unit 21 causes the generative AI model 3 to determine an item that matches with the discrimination criterion as a target item from items in the document 31 based on the item type table 32 associated with this specified document type.

According to the present embodiment, it is possible use an appropriate input prompt according to the type of the document 31, so that it is possible to more accurately extract desired information from the document 31.

### Third Embodiment

In the first embodiment, in a case where there is additional information in the extracted information 33, a new condition is added to a prompt sentence of the item type table 32. By contrast with this, correction (e.g., deletion) of a prompt sentence is also performed in the present embodiment, which is different from the first embodiment.

The prompt generation system 1 performs the extraction processing described with reference to FIG. 10 and the like every time, for example, the document 31 is input, and acquires a plurality of pieces of the extracted information 33. The condition determination unit 23 calculates an extraction rate that is a rate of extraction of information matching with the programmatic determination condition, based on the plurality of pieces of extracted information 33 and the item type table 32, and deletes a sentence for designating information matching with this programmatic determination condition from a prompt sentence in the item type table 32 if this extraction rate is less than a threshold.

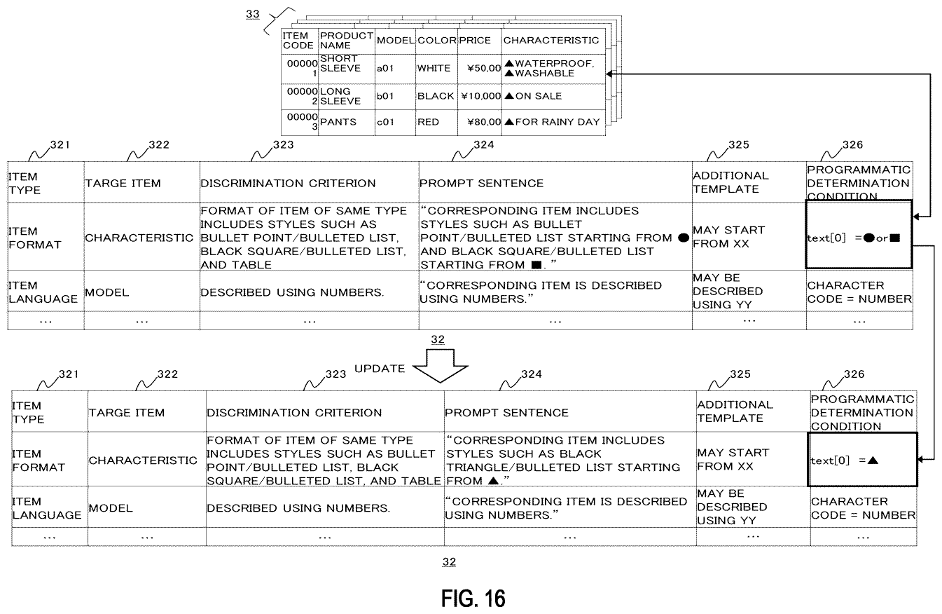

FIG. 16 is a diagram illustrating an example of the update processing according to the present embodiment.

In an example in FIG. 16, in the item “characteristic” of the extracted information 33, a rate of item information starting from “•” or “▪” is less than the threshold, and there is additional information starting from “▴”. In this case, the condition determination unit 23 updates an input prompt associated with the “characteristic” in the item type table 32 from “Corresponding item includes styles such as bullet point/bulleted list starting from • and black square/bulleted list starting from ▪.” to “Corresponding item includes styles such as black triangle/bulleted list starting from ▴.”.

According to the present embodiment, it is possible to optimize prompt sentences.

The above-described embodiments of the present disclosure are exemplary embodiments for describing the present disclosure, and do not intend to limit the scope of the present disclosure to these embodiments alone. One of ordinary skill in the art can carry out the present disclosure in various aspects without departing from the scope of the present disclosure.

What is claimed is:

1. A prompt generation system generating an input prompt for causing a generative AI model to extract information from a document, the prompt generation system comprising:
a processor; and
a memory, wherein
the memory is configured to store a prompt sentence for designating extraction target information to be extracted from the document, and
the processor is configured to
generate the input prompt including the prompt sentence so as to be input to the generative AI model, and
discriminate additional information that is included in extracted information extracted by the generative AI model in response to the input prompt and that does not correspond to the extraction target information, and add to the prompt sentence a sentence for designating the extraction target information that is new and matches the additional information.

2. The prompt generation system according to claim 1, wherein
item information associated with each item is described per item in the document, and
the memory is configured to store per predetermined target item included in the item a prompt sentence for designating item information, associated with the predetermined target item, as the extraction target information.

3. The prompt generation system according to claim 2, wherein
a characteristic of the target item is stored, per target item, in the memory, and
the processor is configured to cause the generative AI model to specify as the target item an item matching with the characteristic from items in the document, and generate the input prompt including a prompt sentence associated with the specified target item.

4. The prompt generation system according to claim 1, wherein
the memory is configured to store a determination condition for determining the extraction target information included in the extracted information, and
the processor is configured to determine, as the additional information, information that does not match with the determination condition included in the extracted information on the basis of the determination condition, and add to the determination condition a new condition for determining the additional information as the extraction target information.

5. The prompt generation system according to claim 1, wherein
the memory is configured to store template information of a sentence for designating the new extraction target information, and
the processor is configured to add to the prompt sentence a sentence for designating the new extraction target information by using the template information.

6. The prompt generation system according to claim 1, wherein
the memory is configured to store per type of a document a characteristic of the document of each type and the prompt sentence, and
the processor is configured to cause the generative AI model to determine a type of the document on the basis of based on the characteristic of the document, and generate the input prompt including the prompt sentence associated with the type.

7. The prompt generation system according to claim 1, wherein the processor is configured to calculate a rate of extraction of the extraction target information on the basis of a plurality of pieces of the extracted information extracted by the generative AI model from a plurality of documents, and delete a prompt sentence for designating the extraction target information from the memory when the rate is less than a threshold.

8. The prompt generation system according to claim 1, wherein the processor is configured to display the extracted information.

9. A prompt management method of a prompt generation system generating an input prompt for causing a generative AI model to extract information from a document, wherein
the prompt generation system includes
a processor, and
a memory,
the method comprising:
with the memory, storing a prompt sentence for designating extraction target information to be extracted from the document; and
with the processor,
generating the input prompt including the prompt sentence so as to be input to the generative AI model, and
discriminating additional information that is included in extracted information extracted by the generative AI model in response to the input prompt and that does not correspond to the extraction target information, and adding to the prompt sentence a sentence for designating the extraction target information that is new and matches the additional information.
